(19) United States
(12) Patent Application Publication
(10) Pub. No.: US 2021/0099081 A1
(43) Pub. Date: Apr. 1, 2021

(54) RECTIFYING CIRCUIT AND POWER SUPPLY DEVICE

(71) Applicant: SHARP KABUSHIKI KAISHA, Sakai City (JP)

(72) Inventor: TAKESHI SHIOMI, Sakai City (JP)

(21) Appl. No.: 17/038,599

(22) Filed: Sep. 30, 2020

(30) Foreign Application Priority Data
Oct. 1, 2019 (JP) 2019-181356

(51) Int. Cl. H02M 3/155; H02M 7/217

(52) U.S. Cl. CPC H02M 3/155; H02M 7/217

(57) ABSTRACT

A rectifying circuit includes: a first terminal; a second terminal; a third terminal disposed between the first terminal and the second terminal; a first rectifying element connected to the first terminal and the second terminal; a coil connected to the first terminal and the third terminal; a second rectifying element connected to the third terminal and the second terminal; a transistor including a source, an emitter, a drain, and a collector, the source or the emitter being connected to the third terminal; a power source including a positive electrode and a negative electrode, the negative electrode being connected to the second terminal; and a third rectifying element including an anode connected to the positive electrode of the power source and a cathode connected to the drain or the collector of the transistor.

### CROSS-REFERENCE TO RELATED APPLICATION

The present application claims priority from Japanese Application JP2019-181356, the content of which is hereby incorporated by reference into this application.

### BACKGROUND OF THE INVENTION

### 1. Field of the Invention

The disclosure below relates to a rectifying circuit and a power supply device.

### 2. Description of the Related Art

A rectifying element used in a power supply circuit is known to generate a transient current. This transient current is generated by a reverse voltage being applied to the rectifying element. The transient current produces a loss, and thus various countermeasure methods have been studied.

JP 2011-36075 A and JP 2013-198298 A disclose circuits intended to reduce a transient current.

For example, in the circuit disclosed in JP 2011-36075 A, a diode and a transformer connected in parallel to the rectifying element are provided to reduce a transient current. JP 2013-198298 A also discloses a circuit similar to that in JP 2011-36075 A.

### SUMMARY OF THE INVENTION

However, as described later, there is still room for improvement in measures for reducing the transient current in a rectifying circuit. An object of an aspect of the present disclosure is to effectively reduce a transient current in a rectifying circuit.

To solve the problems described above, a rectifying circuit according to an aspect of the disclosure includes a first terminal, a second terminal, a third terminal disposed between the first terminal and the second terminal, a first rectifying element connected to the first terminal and the second terminal, a coil connected to the first terminal and the third terminal, a second rectifying element connected to the third terminal and the second terminal, a transistor including a source, an emitter, a drain, and a collector, the source or the emitter being connected to the third terminal, a power source including a positive electrode and a negative electrode, the negative electrode being connected to the second terminal, and a third rectifying element including an anode connected to the positive electrode of the power source and a cathode connected to the drain or the collector of the transistor. The rectifying circuit is configured to cause a rectified current to flow from the second terminal toward the first terminal.

With the rectifying circuit according to an aspect of the present disclosure, it is possible to effectively reduce a transient current.

### BRIEF DESCRIPTION OF THE DRAWINGS

FIG. 1 is a diagram illustrating a circuit configuration of a power supply circuit according to a first embodiment.

FIG. 2 is a diagram showing waveforms of each voltage and current.

FIG. 3 is a diagram showing each graph of FIG. 2 enlarged.

FIG. 4 is a diagram for explaining a path of each current in first to fourth steps.

FIG. 5 is a diagram showing waveforms of each voltage and current in a power supply circuit of a comparative example.

FIG. 6 is a diagram illustrating a power supply device according to a second embodiment.

### DETAILED DESCRIPTION OF THE INVENTION

### First Embodiment

A rectifying circuit 1 and a power supply circuit 10 of a first embodiment will be described below. Note that, for convenience of description, in each embodiment hereinafter, components having the same functions as those of components described in the first embodiment are denoted using the same reference numerals, and descriptions thereof will not be repeated.

### Purpose of Rectifying Circuit 1

As described above, a transient current is generated by a reverse voltage being applied to a rectifying element. The transient current generated in a rectifying element in which a PN junction is formed is also referred to as a reverse recovery current.

On the other hand, a transient current is also generated in a rectifying element in which a PN junction is not formed. In such a rectifying element, a charging current of a parasitic capacitance caused by application of the reverse voltage flows as a transient current. Examples of semiconductor elements in which a PN junction is not formed include a SiC Schottky barrier diode (SBD) and a GaN high electron mobility transistor (HEMT).

The rectifying circuit 1 is created for the purpose of reducing these transient currents.

### DEFINITIONS OF TERMS

Prior to describing the rectifying circuit 1, each term is defined in the present specification as follows.

The term “forward voltage” refers to a voltage for causing a forward current to flow to a rectifying element.

Consider, as a first example, a case where the rectifying element is a diode. In this case, the forward voltage refers to a voltage applied to cause a forward current to flow to the diode.

Consider, as a second example, a case where the rectifying element is a transistor. In this case, the forward voltage refers to a “voltage allowing a rectified current to be conducted in a case where a positive voltage is applied to the source based on the drain when the gate is OFF.”

The two examples described above are the same as applying a positive voltage to second terminal ST1 (described later) based on a first terminal FT1 (described later) of the rectifying circuit 1. The size of the forward voltage depends on the type of element, but is, for example, from 0.1 V to 5 V. The size of the forward current that occurs in association with application of the forward voltage depends on the current of the inductive element, such as coil, but is, for example, from 0.1 A to 100 A.

The term “rectified current” refers to a forward current flowing in a rectifying element or a rectifying circuit.

The term “reverse voltage” refers to a voltage applied to the rectifying element or the rectifying circuit such that a forward current does not flow.

Consider, as a first example, a case where the rectifying element is a diode. In this case, the voltage applied such that a forward current does not flow to the diode is the reverse voltage.

Consider, as a second example, a case where the rectifying element is a transistor. In this case, the reverse voltage refers to a “positive voltage applied to the drain based on the source when the gate is OFF.”

The two examples described above are the same as applying a positive voltage to FT1 based on ST1 of the rectifying circuit 1. The size of the reverse voltage depends on circuit specifications, but is, for example, from 1 V to 1200 V.

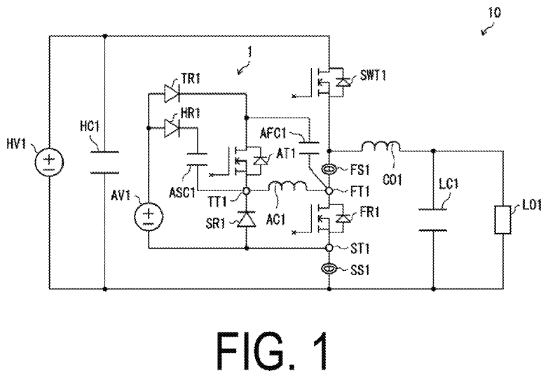

The term “transient current” generally refers to a reverse recovery current and a charging current of the parasitic capacitance of a rectifying element. That is, the transient current refers to a transient current that occurs in a case where a reverse voltage is applied to a rectifying element. In the example of FIG. 1, the transient current can be measured at the positions of FS1 and SS1.

The term “rectifier function” refers to a function that causes a current to flow in one direction only.

Consider, as a first example, a case where the rectifying element is a diode. In this case, the rectifier function refers to the function of the diode conducting the forward current and blocking the reverse current.

Consider, as a second example, a case where the rectifying element is a transistor. In this case, the rectifier function refers to a function that conducts current from the source to the drain and blocks current from the drain to the source when the gate is OFF. According, the presence or absence of parasitic diode is not considered.

The term “rectifying element” generally refers to an element having a rectifier function.

The term “transistor function” refers to a function that switches whether a current flows from the drain toward the source based on ON/OFF of the gate of the transistor. Of course, to cause current to flow, it is also necessary to apply a positive voltage to the drain based on the source.

Note that in a case where the element is a bipolar transistor, an insulated gate bipolar transistor (IGBT), or the like, (i) the drain can be considered a collector, and (ii) the sour can be considered emitter.

The term “transistor element” generally refers to an element having a transistor function. A metal oxide semiconductor field effect transistor (MOSFET) and a GaN-HEMT correspond to transistor elements. In both cases, the transistor function and the rectifier function are combined.

### Overview of Configuration of Power Supply Circuit 10

FIG. 1 is a diagram illustrating a circuit configuration of the power supply circuit 10 according to the first embodiment. The power supply circuit 10 is a step-down DC/DC converter that converts a high voltage into a low voltage. In the power supply circuit 10, a known rectifying element of the step-down DC/DC converter is replaced with the rectifying circuit 1. Note that each. of the numerical values described below is merely an example.

### Configuration of High-Voltage Portion of Power Supply Circuit 10

A high-voltage portion is provided with a power source HV1 and a capacitor HC1. In the following description, for purposes of simplicity of description, “the power source HV1” is simply referred to as “HV1,” for example. The (+) side of the power supply symbols in FIG. 1 indicates a positive electrode side, and the (−) side indicates a negative electrode side. HV1 has a voltage of 0 V on the negative electrode side, and a voltage of 400 V on the positive electrode side. The electrostatic capacitance of HC1 is 1 mF.

### Configuration of Low-Voltage Portion of Power Supply Circuit 10

A low-voltage portion is provided with a coil CO1, a capacitor LC1, and a load LO1. CO1 has an inductance of 1 mH and an average current of 12.5 A. LC1 has an electrostatic capacitance of 1 mF and a voltage of 200 V. LO1 is a load resistor that consumes 2.5 kW of power. In the power supply circuit 10, the voltage of LC1 is designed to be one half the voltage of HV1.

### Configuration of Rectifying Circuit 1 of Power Supply Circuit 10

A typical rectifying circuit includes only a first rectifying element FR1 as a rectifying element. In contrast, in addition to the first rectifying element FR1, the rectifying circuit 1 is further provided with a second rectifying element SR1, a third rectifying element TR1, a fourth rectifying element SR1, a coil AC1, a transistor AT1, a first capacitor AFC1, a second capacitor ASC1, and a power source AV1.

The “first rectifying element FR1” is a cascade-type GaN-HEMT. FR1 has a drain withstand voltage of 650 V and an on-resistance of 50 mΩ. In the example of FIG. 1, the cascade GaN-HEMT is represented. by using the circuit symbol of a metal oxide semiconductor field effect transistor (MOSFET).

The “second rectifying element SR1” a SiC-SBD having a withstand voltage of 650 V. The forward voltage of SR1 at a point in time when conduction starts is 0.9 V. The resistance of SR1 when the forward current is flowing is 50 mΩ.

The “third rectifying element TR1” is a fast recovery diode (FRD) having a reverse withstand voltage of 600 V. The forward voltage of TR1 at a point in time when conduction starts is 0.9 V. The resistance of TR1 during conduction. is 0.1 Ω.

The “fourth rectifying element SRI” is a diode of the same type as TR1.

The “coil AC1” is a coil having an inductance of 1 μH and a DC resistance of 50 mΩ.

The “transistor AT1” is a MOSFET having an on-resistance of 40 mΩ).

The “first capacitor AFC1” is a capacitor having an electrostatic capacitance of 100 μF.

The “second capacitor ASC1” is a capacitor having an electrostatic capacitance of 1 μF.

The “power source AV1” is a power source having a voltage of 15 V.

The “first terminal FT1” refers to an electrical connection point between FR1, AC1, and AFC1.

The “second terminal ST1” refers to an electrical connection point between FR1, SR1, and AV1.

The “third terminal TT1” refers to an electrical connection point between SR1, AC1, AT1, and ASC1.

“FS1 and SS1” refer to portions where the current of the rectifying circuit 1 can be measured. At FS1 and SS1, the same current values are observed. Any current sensor can be used as the current sensor. For example, a Hall element-type current sensor, a current transformer (CT) sensor, a Rogowski coil, or a shunt resistor be used as the current sensor.

### Configuration of Transistor Function Unit of Power Supply Circuit 10

The transistor function unit is provided with a transistor SWT1. As SWT1, an element of the same type as FR1 is used.

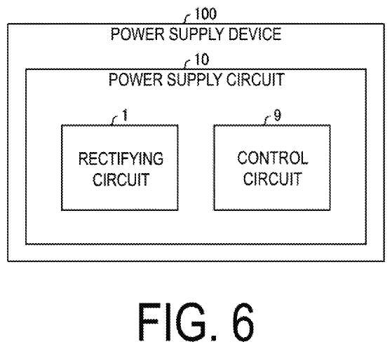

The gate terminal of each element of the power supply circuit 10 is connected to a control circuit 9, described later, illustrated in FIG. 6. Accordingly, the ON/OFF switching of the gate is performed by the control circuit 9.

### Circuit Configuration of Comparative Example

A power supply circuit 10r (not illustrated) is a step-up DC/DC converter of comparative example. The power supply circuit 10r has a configuration in which the rectifying circuit of the power supply circuit 10 is replaced with FR1 only. First, the operation of the power supply circuit 10r and the transient current will be described, and subsequently the power supply circuit 10 will be described.

### Operation 1 of Comparative Example

First, in the ON period of SWT1, the voltage of the switch node is approximately 400 V. Therefore, a voltage of approximately 200 V is applied to CO1, increasing the coil current. The coil current follows the path “HV1 positive electrode→SWT1→CO1→LO1→HV1 negative electrode.”

### Operation 2 of Comparative Example

Then, SWT1 is switched to OFF. As a result, due to the electromotive voltage of CO1, the voltage of ST1 is approximately 1 V greater than the voltage of FT1. This voltage of approximately 1 V is applied to FR1 as a forward voltage, and a rectified current flows from FR1 to CO1. The rectified current follows the path “LO1→FR1→CO1→LO1.”

### Operation 3 of Comparative Example

Then, SWT1 is switched to ON. As a result, the voltage of the switch node is approximately 400 V. Thus, a reverse voltage of approximately 400 V is applied to FR1, causing a transient current to flow.

These operations 1 to 3are iterated at a frequency of 100 kHz. The duty cycle of SWT1 is 50%. Therefore, every 5 μs, the forward voltage and the reverse voltage are alternately applied to FR1.

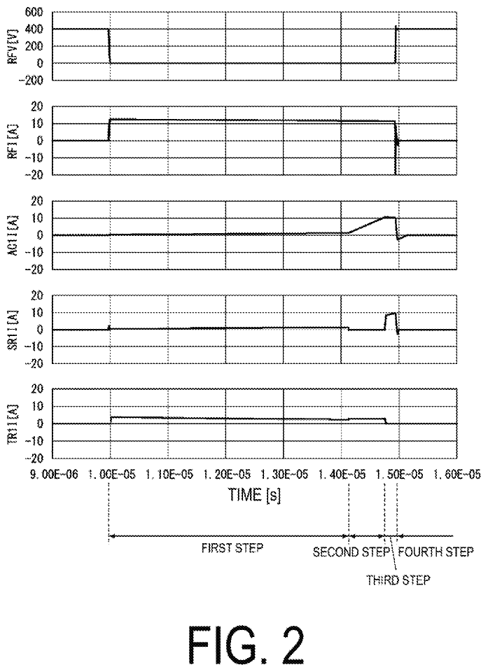

### Description of FIG. 2 to FIG. 4 Used in Operation Explanation of Rectifying Circuit 1

FIG. 2 is a graph showing waveforms of a voltage and a current of each portion of the rectifying circuit 1. These waveforms are shown based on a common time axis (horizontal axis). Each of the waveforms shown in FIG. 2 indicates the following:

RFV (voltage of rectifying circuit 1): Voltage applied to FT1 based on ST1;

RFI (current of rectifying circuit 1): Current flowing from ST1 to FT1;

AC1I (current of AC1): Current flowing from TT1 to FT1;

SR1I (current of SR1): Current flowing from ST1 to TT1;

TR1I (current of TR1): Current flowing from anode to cathode. The timing of first to fourth steps (described later) is indicated on the horizontal axis in FIG. 2.

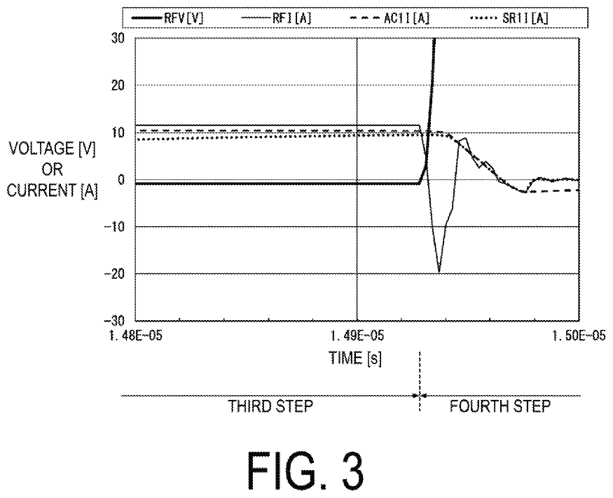

FIG. 3 is an enlarged view of RFV, RFI, AC1I, and SR1I in FIG. 2 compiled in one graph. In FIG. 3, for convenience of the enlarged view, RFV extends beyond the upper edge of the graph.

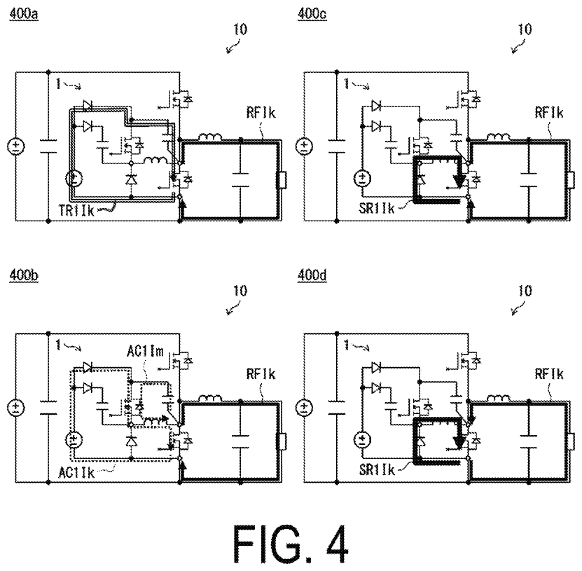

FIG. 4 is a diagram for explaining the path of each current in the first to fourth steps. Specifically, 400a to 400d in FIG. 4 correspond to the current paths in the first to fourth steps, respectively. For convenience of illustration, in FIG. 4, the reference numerals of the elements in FIG. I are omitted.

### Drive Method in Rectifying Circuit 1: First Step to Fourth Step

According to the drive method of the rectifying circuit 1, the four steps below are executed in order.

First step: Applying a forward voltage to the rectifying circuit 1 and thus causing a rectified current to flow

Second step: Turning AT1 to ON and thus causing a current to flow to AC1

Third step: Turning AT1 to OFF and thus causing a current to flow to SR1

Fourth step: Applying a reverse voltage to the rectifying circuit 1 and thus stopping the rectified current

### First Step: Causing Rectified Current to Flow to Rectifying Circuit 1

Prior to the first step, current is flowing from SWT1 toward CO1. Thus, in the first step, SWT1 is turned to OFF, generating an electromotive voltage in CO1. This electromotive voltage allows a forward voltage of approximately 1 V to be applied to the rectifying circuit 1. As a result, a rectified current can be caused to flow to FR1. This rectified current flows through the path indicated by RFIk in 400a of FIG. 4.

Note that, in the first step, the current flowing to SR1 is less than the current flowing to FR1. Therefore, in 400a of FIG. 4, unlike 400c to 400d of FIG. 4, SR1I is not illustrated.

Further, in this first step, due to the conduction of FRI, the voltage of FT1 is approximately −1 V. Therefore, AFC1 is charged in the path of a TR1Ik. Without AFC1, this TR1Ik substantially does not flow.

### Second Step: Causing Current to Flow to AC1

Following the first step, AT1 is turned to ON, causing AC1I to flow. This AC1I is the sum of the current from TR1 and the current from AFC1. That is, AC1I flows through the two paths (AC1Ik and AC1Im) illustrated in 400b of FIG. 4. With AC1I in this second step, energy is stored in the coil.

### Third Step: Causing Current to Flow to SR1

Following the second step, ATI is turned to OFF, causing SR1I to flow. SR1I flows through a path SR1Ik illustrated in 400c in FIG. 4. That is, the energy of the coil flows after becoming SR1I.

The current path of SR1I may also be described from another standpoint. In particular, the current flowing to FR1 in 400c of FIG. 4 will be described. FR1 in 400c of FIG. 4 illustrates both an upward RFIk and a downward SR1Ik. The flow of the two currents in FR1 in mutually opposite directions means that the two current values offset each other.

### Fourth Step: Applying Reverse Voltage to Rectifying Circuit 1

In the fourth step, SWT1 is turned to ON to apply 400 V, which is the reverse voltage, to the rectifying circuit 1. The method of applying the reverse voltage may be selected from a variety of methods according to the type of power supply circuit.

Concurrent with the application of the reverse voltage, a transient current (RFI in the reverse direction.) that charges the parasitic capacitance of FR1 occurs. The transient current flow's along the path indicated by RFIk in 400d of FIG. 4. Further, although not illustrated in 400d of FIG. 4, current flows along the path “HV1 positive electrode→SWT1→CO1→LO1 →HV1 negative electrode” from the start point of the fourth step.

In this fourth step, the voltage of FT1 is 400 V. Therefore, the voltage of the positive electrode of AFC1 is 415 V. The electric discharge from this 415 V node (positive electrode of AFC1) to the positive electrode (15 V) of AV1 is inhibited by TR1.

Similarly, the voltage of the positive electrode of ASC1 is also 415 V. The electric discharge from this 415 V node (positive electrode of ASC1) to the positive electrode (15 V) of AV1 is inhibited by HR1.

### Principles of Transient Current Reduction by FR1I

In the rectifying circuit 1, when SR1I flows along the path that charges the parasitic capacitance of FR1, a reverse voltage is applied, causing a transient current to flow. That is, the parasitic capacitance of FR1 can be charged by SR1I and RFI. Therefore, the transient current is a value obtained by subtracting an amount equivalent to SR1I. That is, the transient current can be effectively reduced compared to the related art.

### Comparison of Transient Current and Confirmation of Reduction Effect

The transient current of the power supply circuit 10r of the comparative example will now be compared with the transient current of the power supply circuit 10, and the effect of reducing the transient current with the rectifying circuit 1 will be confirmed.

### Transient Current of Comparative Example

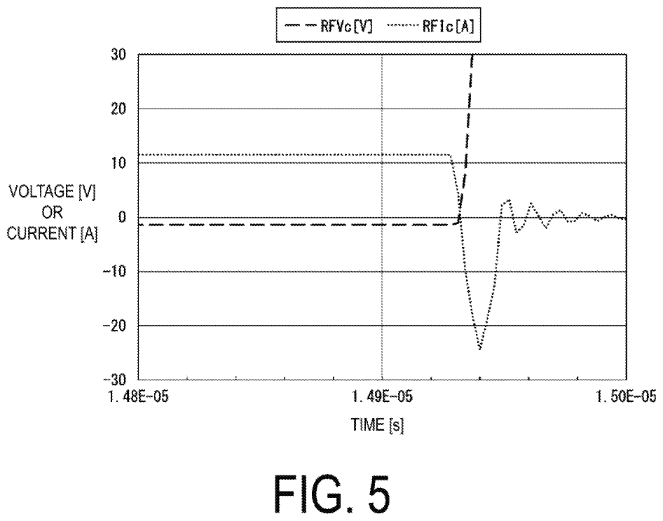

FIG. 5 is a graph showing waveforms of a rectifying circuit voltage (RFVc) and a rectifying circuit current (RFIc) in the power supply circuit 10r serving as the comparative example. The scales of the horizontal axis and vertical axis in the graph of FIG. 5 are set to the same scales as in the graph in FIG. 3.

As shown in FIG. 5, in the comparative example, it is understood that RFIc of negative 25 A, which is the transient current, is flowing. The reverse voltage (RFVc), which is the voltage applied to the rectifying circuit, is 400 V, as in the example of FIG. 3.

### Transient Current of Rectifying Circuit 1

The transient current in the rectifying circuit 1 of the power supply circuit 10 will now be described with reference to FIG. 3. In the example of FIG. 3, the size of the transient current (negative RFI) is 20 A. Thus, according to the rectifying circuit 1, it is confirmed that the transient current can be reduced further than in the comparative example.

### Improvements 1 to 3 for Efficiently Operating Rectifying Circuit 1

In the first embodiment, a plurality of preferred improvements are applied. These preferred improvements will be described below.

### Improvement 1: AT1 Turned to ON When Rectified Current Flows to Rectifying Circuit 1

The flow of the rectified current to FR1 causes a conduction loss. In the first embodiment, AC1I flows along the path of AC1Ik in the second step. This is to store the energy of the coil used for transient current reduction, as described above. This AC1Ik is in a direction reverse to RFIk at the position of FR1. FR1I is offset by the current in the reverse direction, thereby reducing the conduction loss of FR1 in the second step.

### Improvement 2: Smoothing TR1I by Connection of AFC1

AFC1 is not required for the purpose of transient current reduction. The purpose of providing AFC1 is to reduce the conduction toss of TR1. In the second step, in a case where there is no AFC1, AC1I is supplied from TR1I. TR1I at that time is approximately 10 A. When AFC1 is connected, AC1I is provided with an additional current supply from AC1Tm. As a result, TR1I is reduced to approximately 3 A. TR1I in the first step period is the charging current of AFC1. In this way, TR1I is smoothed by the connection to AFC1, thereby reducing conduction loss.

### Improvement 3: Creating Gate Drive Power Source tor AT1 Using HR1 and ASC1

AT1 also requires a gate drive power source. In the first embodiment, a gate drive power source for AT1 is created using HR1 and ASC1.

In the period in which the rectified current flows to the rectifying circuit 1, ASC1 is charged via HR1, thereby ensuring a gate drive power source. The charging path of ASC1 is “AV1 positive electrode→HR1→ASC1→AC1→FR1→AV1 negative electrode.”

In this way, the gate drive power source for AT1 is created by a simplified circuit.

### Modified Example: Scope of Application of Element

In the first embodiment, an example is given in which FR1 is a cascade GaN-HEMT, SR1 is a SiC-SBD, and TR1 and HR1 are FRDs. The types of these elements are not particularly limited to a specific type as long as they fall within the scope of the elements described above. Similarly, the type of SWT1 is not particularly limited as long as the type has a transistor function. Further, applying synchronous rectification that is commonly used for rectifying elements makes it possible to reduce conduction loss.

### Second Embodiment

A rectifying circuit according to an aspect of the present disclosure can be applied to a power supply circuit that uses a rectifying circuit. Examples of the power supply circuit include a chopper circuit, an inverter circuit, and a power factor correction (PFC) circuit.

FIG. 6 is a diagram illustrating a power supply device 100 provided with the power supply circuit 10. According to the rectifying circuit 1, loss in the power supply circuit 10 and the power supply device 100 can be reduced. Furthermore, the power supply circuit 10 includes the control circuit 9. The control circuit 9 controls the ON/OFF switching of the elements provided in the power supply circuit 10. The first to fourth steps may be performed by the control circuit 9 controlling the ON/OFF of each element provided in the power supply circuit 10.

### Supplement

A rectifying circuit according to a first aspect of the present disclosure includes a first terminal, a second terminal, a third terminal disposed between the first terminal and the second terminal, a first rectifying element connected to the first terminal and the second terminal, a coil connected to the first terminal and the third terminal, a second rectifying element connected to the third terminal and the second terminal, a transistor including a source, an emitter, a drain, and a collector, the source or the emitter being connected to the third terminal, a power source including a positive electrode and a negative electrode, the negative electrode being connected to the second terminal, and a third rectifying element including an anode connected to the positive electrode of the power source and a cathode connected to the drain or the collector of the transistor. The rectifying circuit is configured to cause a rectified current to flow from the second terminal toward the first terminal.

As described above, a transient current generates a loss in a circuit. Thus, the inventors of the present application discovered the configuration described above based on the idea that “energy of a coil leads to suppression of transient current.”

According to the configuration described above, the transistor is turned to ON, thereby causing a current to flow to the coil and energy to be stored. Then, the transistor is turned to OFF, thereby converting the energy into a current flowing to the second rectifying element (second rectifying element current) and reducing the transient current.

This second rectifying element current is used for causing a current component, which is the transient current, to flow in a path formed by the coil, the second rectifying element, and the first rectifying element.

In a rectifying circuit according to a second aspect of the present disclosure, the transistor further includes a gate that, by being turned to ON during a period in which the rectified current flows to the rectifying circuit, is configured to cause some of the rectified current of the rectifying circuit to flow to the third rectifying element.

According to the configuration described above, the rectified current flowing to the first rectifying element or the second rectifying element can be diverted to the third rectifying element. Accordingly, the conduction loss of the rectifying circuit is reduced.

A rectifying circuit according to a third aspect of the present disclosure further includes a first capacitor including a positive electrode connected to a drain or a collector of the transistor, and a negative electrode connected to the first terminal.

According to the configuration described above, the rectified current flowing to the third rectifying element can be smoothed, and thus the conduction loss can be reduced.

A rectifying circuit according to a fourth aspect of the present disclosure further includes a second capacitor including a positive electrode and a negative electrode, the negative electrode being connected to the third terminal, and a fourth rectifying element including an anode connected to the positive electrode of the power source, and a cathode connected to the positive electrode of the second capacitor.

According to the configuration described above, the negative electrode of the second capacitor and the source or the emitter of the transistor can be used as a node having the same potential. Therefore, the second capacitor can be used as a power source for driving the gate of the transistor.

A power supply device according to a fifth aspect of the present disclosure includes the rectifying circuit according to an aspect of the present disclosure.

According to the configuration described above, a power supply device with reduced loss can be provided by using the rectifying circuit with a reduced transient current.

### Supplementary Information

An aspect of the present disclosure is not limited to each of the embodiments described above. It is possible to make various modifications within the scope indicated in the claims. An embodiment obtained by appropriately combining technical elements each disclosed in different embodiments falls also within the technical scope of an aspect of the present disclosure. Furthermore, technical elements disclosed in the respective embodiments may be combined to provide a new technical feature.

1. A rectifying circuit comprising:
a first terminal;
a second terminal;
a third terminal disposed between the first terminal and the second terminal;
a first rectifying element connected to the first terminal and the second terminal;
a coil connected to the first germinal and the third terminal;
a second rectifying element connected to the third terminal and the second terminal;
a transistor including a source, an emitter, a drain, and a collector, the source or the emitter being connected to the third terminal;
a power source including a positive electrode and a negative electrode, the negative electrode being connected to the second terminal; and
a third rectifying element including an anode connected to the positive electrode of the power source and a cathode connected to the drain or the collector of the transistor,
the rectifying circuit being configured to cause a rectified current to flow from the second terminal toward the first terminal.

2. The rectifying circuit according co claim 1,
wherein the transistor further includes a gate that, by being turned to ON during a period in which the rectified current flows to the rectifying circuit, is configured to cause some of the rectified current of the rectifying circuit to flow to the third rectifying element.

3. The rectifying circuit according to claim 1, further comprising:
a first capacitor including a positive electrode connected to the drain or the collector of the transistor, and a negative electrode connected to the first terminal.

4. The rectifying circuit according to claim 2, further comprising:
a first capacitor including a positive electrode connected to the drain or the collector of the transistor, and a negative electrode connected to the first terminal.

5. The rectifying circuit according to claim 1, further comprising:
a second capacitor including a positive electrode and a negative electrode, the negative electrode being connected to the third terminal; and
a fourth rectifying element including an anode connected to the positive electrode of the power source, and a cathode connected to the positive electrode of the second capacitor.

6. The rectifying circuit according to claim 2, further comprising:
a second capacitor including a positive electrode and a negative electrode, the negative electrode being connected to the third terminal; and
a fourth rectifying element including an anode connected to the positive electrode of the power source, and a cathode connected to the positive electrode of the second capacitor.

7. The rectifying circuit according to claim 3, further comprising:
a second capacitor including a positive electrode and a negative electrode, the negative electrode being connected to the third terminal; and
a fourth rectifying element including an anode connected to the positive electrode of the power source, and a cathode connected to the positive electrode of the second capacitor.

8. The rectifying circuit according to claim 4, further comprising:
a second capacitor including a positive electrode and a negative electrode, the negative electrode being connected to the third terminal; and
a fourth rectifying element including an anode connected to the positive electrode of the power source, and a cathode connected to the positive electrode of the second capacitor.

9. A power supply device comprising:
the rectifying circuit of claim 1.
